(19) United States
(12) Patent Application Publication
(10) Pub. No.: US 2005/0131818 A1
(43) Pub. Date: Jun. 16, 2005

(54) Method for performing Due diligence and legal, financial and other types of audits

(76) Inventors: Nishith Madanlal Desal, Maharashtra (IN); Vaibhav Kamal Parikh, Maharashtra (IN)

Correspondence Address: Nishith Madanial Desel, Suite 201, 220 California Av, Palo Alto, CA, 94306, US

(21) Appl. No.: 10/921,755

(22) Filed: Aug. 19, 2004

Related U.S. Application Data
(60) Provisional application No. 60/496,648, filed on Dec. 15, 2003.

(51) Int. Cl. G06F 17/60

(52) U.S. Cl. 705/40

(57) ABSTRACT

The present invention is directed to providing due diligence and legal, financial and various other types of auditing services in a manner that reduces inefficiency, cost, and human error by substantially automating the process.

### RELATED APPLICATIONS:

This application claims priority to U.S. provisional application No. 60/496,648 filed on Aug. 21, 2003, which is hereby incorporated by reference.

### FIELD OF INVENTION:

The present invention pertains to a system and method for performing due diligence and legal, financial and other types of audits. More particularly, the invention relates to a system and method for determining a consequence of an entity performing one or more acts as per a predetermined standard pertaining to the performed act.

### BACKGROUND OF THE INVENTION:

Due diligence is a process of acquiring objective and reliable information about a person or an entity prior to a specific event, such as the sale of a business or asset. For example, an entity seeking to acquire a target company may conduct a due diligence investigation to validate the assets and liabilities of the target company before committing to the acquisition. The nature and extent of the information collected is typically customized to ensure that it meets the needs of a particular transaction. Risk and fraud are not always obvious, hence care and prudence is needed to obtain accurate and relevant information that can be used to make informed decisions.

Due diligence is a safety net, important for buyers and sellers alike. Due diligence is about the management of risk. A proper due diligence investigation requires detailed information about many different aspects of an entity, including its legal and financial obligations, management and employment issues, tangible and intangible assets, contracts, pending litigation, and business strategies. Effective due diligence is both an art and a science. The art of due diligence lies in asking intelligent questions that can hone in on and elucidate information needed for a proper understanding of the business or transaction under consideration. The science of due diligence is in the preparation of comprehensive and customized checklists detailing the specific questions that should be presented to the information provider. It involves maintaining a methodical system for organizing and analyzing the documents, data, and information provided by the information provider, and then quantitatively assessing the risks associated with any issues or problems discovered during the process. One of the key concerns is detection of a target's obligations, particularly those that the acquirer will be expected or required to assume. The due diligence process is designed first to detect the existence of the obligation, and then to identify any problems posed in connection with these obligations that will affect the buyer. The professionals involved are required to recommend and/or provide solutions to the problems thereafter. The buyer can ensure a reliable transaction given a detailed and informative due diligence report, and subsequent preparation and planning based on such a report.

Generally legal, financial and various other types of audits are conducted as a self-assessment. Companies generally conduct various types of audits to check their compliance with legal regulations and assess the financial risk associated with their operations. An audit compliant company not only re-establishes its brand name, but also promotes the interest of its stakeholders. The information and documents required for a legal audit and other audits are similar to those described for due diligence.

The nature and extent of a due diligence investigation or legal, financial and various other types of audits varies with the type and object of the business or transaction under consideration. Moreover, the efficiency and effectiveness of the data collection depends on the experience and knowledge of the information collector. For example, a lawyer with experience in legal due diligence will ask questions based on his own experience and the problems he has faced in prior dealings. Inexperience or oversight on the part of the information collector can lead to wasted time and money, and will occasionally result in a failure to address one or more important problems. For example, numerous visits to an information provider's offices might be required during a due diligence investigation, leading to increases in the time and expenditure involved in the process.

Hence, there exists a need for a method of executing a due diligence investigation or legal, financial and various other types of audits that reduces cost and the amount of human error involved in the process, while ensuring a high-quality final report.

Another common drawback encountered during the due diligence or legal, financial and various other types of audits process is the generation of one common report for all professionals. The disadvantage of such a report is that it often fails to highlight the issues and recommendations that have particular importance to only one or two individuals in an organization. For example, a CEO reviewing a due diligence or legal, financial and various other types of audit report might be interested in specific information that differs from the information that a CFO or attorney is most interested in. The generation of customized reports that emphasize the information that a particular recipient needs would be much more beneficial. The production of reports customized for a reviewing professional, however, would be an expensive and time-consuming affair if generated using human labor. Thus there is a need in the art for a method of automatically generating reports that are customized for different classes of individuals.

### BRIEF DESCRIPTION OF THE DIAGRAMS

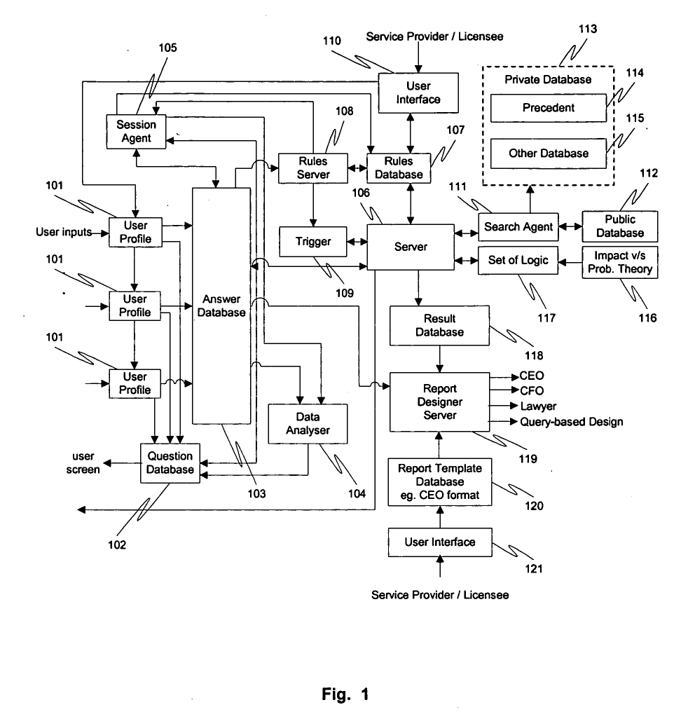

FIG. 1 is a block diagram depicting the architecture of the preferred embodiment, in accordance with the present invention.

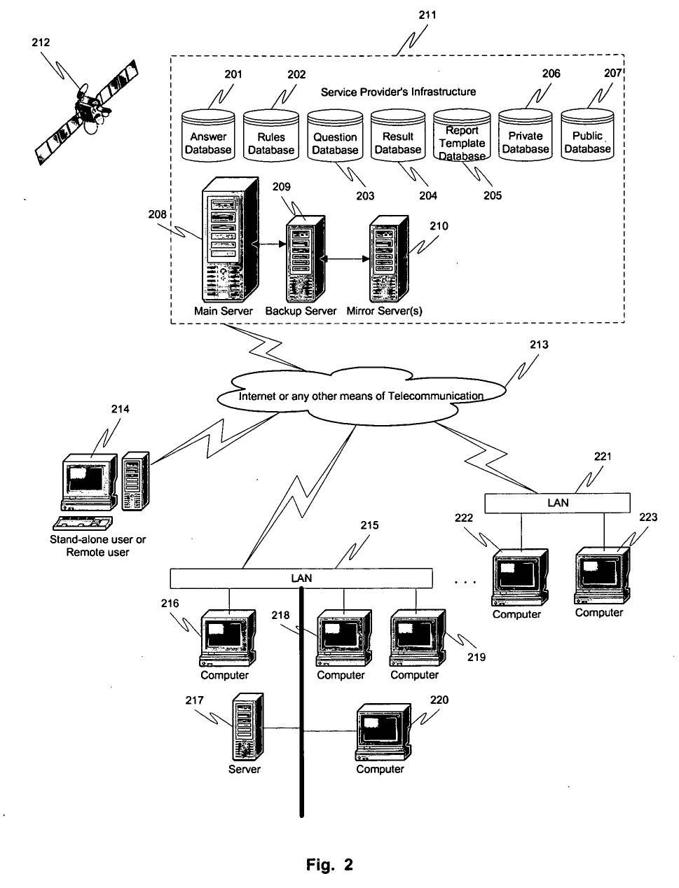

FIG. 2 illustrates the relationship of a service provider with clients subscribing to a service made possible by the present invention. The subscribing clients could either be connected to the Service Provider through the Internet or any other means of telecommunication, using either a stand-alone remote user, a user connected by a Local Area Network, or by two or more separate Local Area Networks.

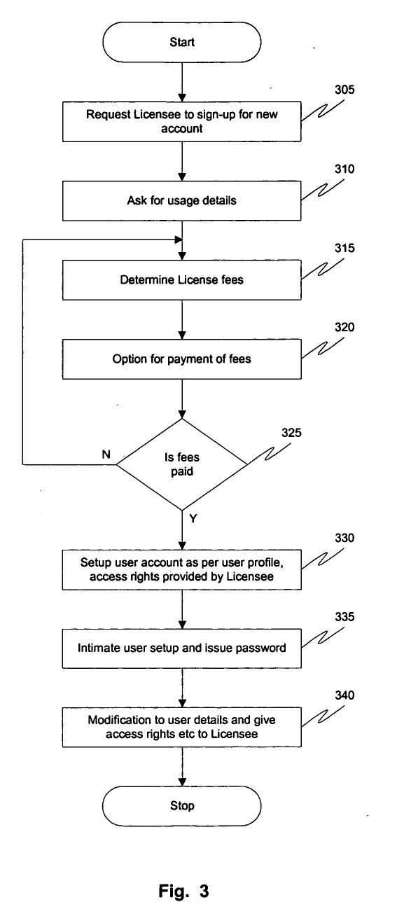

FIG. 3 is a flow diagram illustrating the process wherein a customer or client is requested to sign-up for a new account when he wishes to use the system.

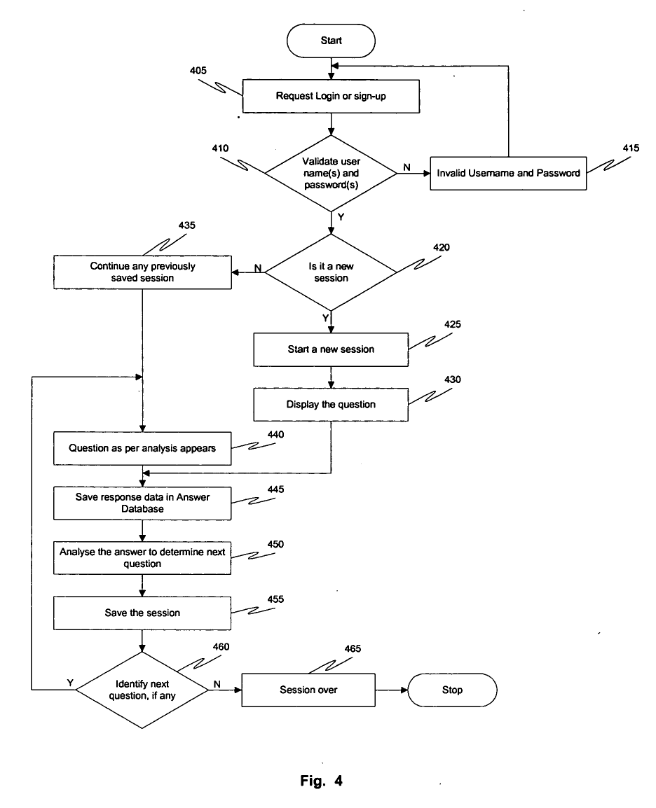

FIG. 4 is a flow diagram illustrating a user's interaction with the system at the data collection phase.

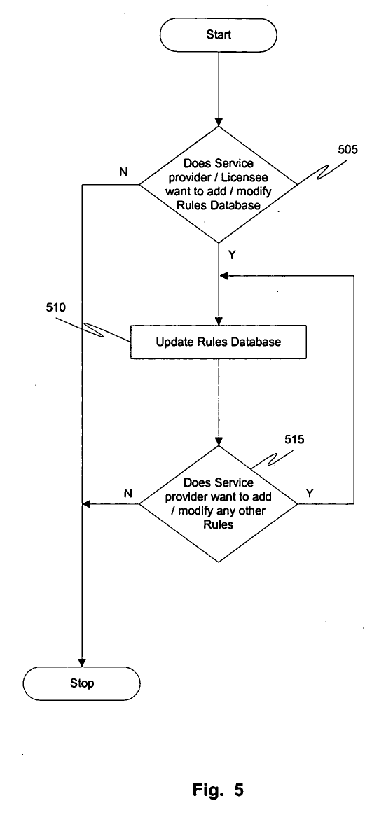

FIG. 5 is a flow diagram illustrating a process by which the Service Provider can modify and update the Rules Database.

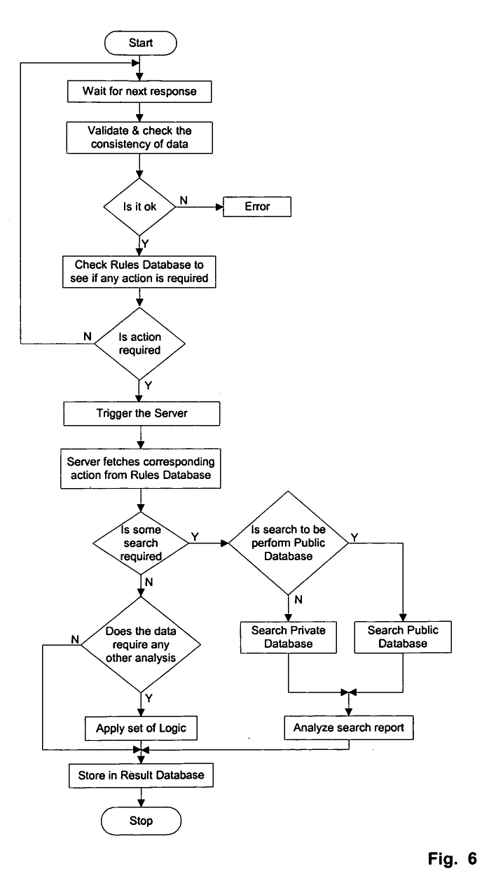

FIG. 6 is a flow diagram illustrating a data process.

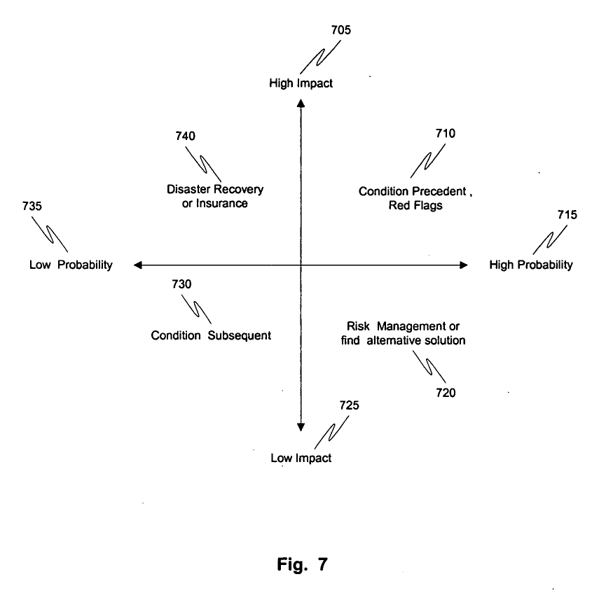

FIG. 7 is a graphical representation of Probability vs. Impact obtained after analyzing the report and as per the intended report audience such as a CEO, CFO, attorney, accountant, or investor.

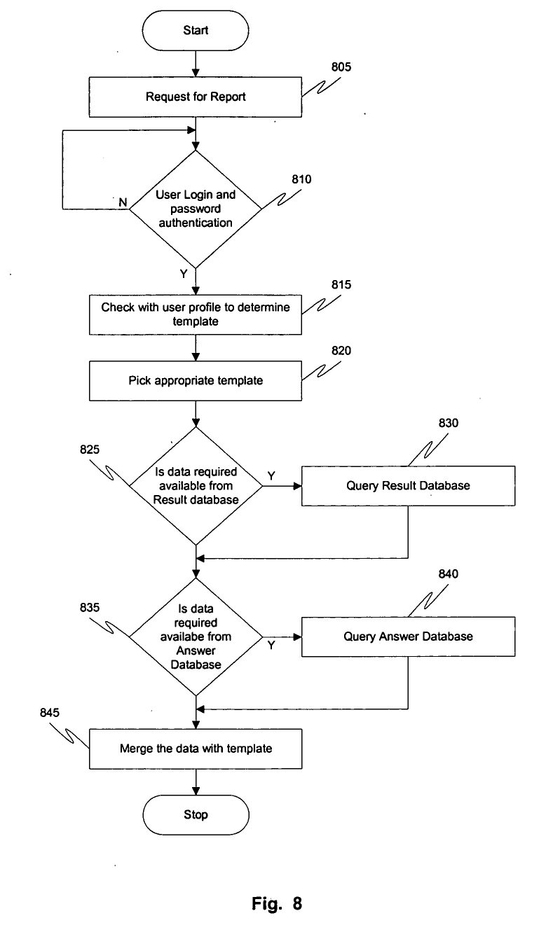

FIG. 8 is a flow diagram illustrating a process by which the system carries out report generation.

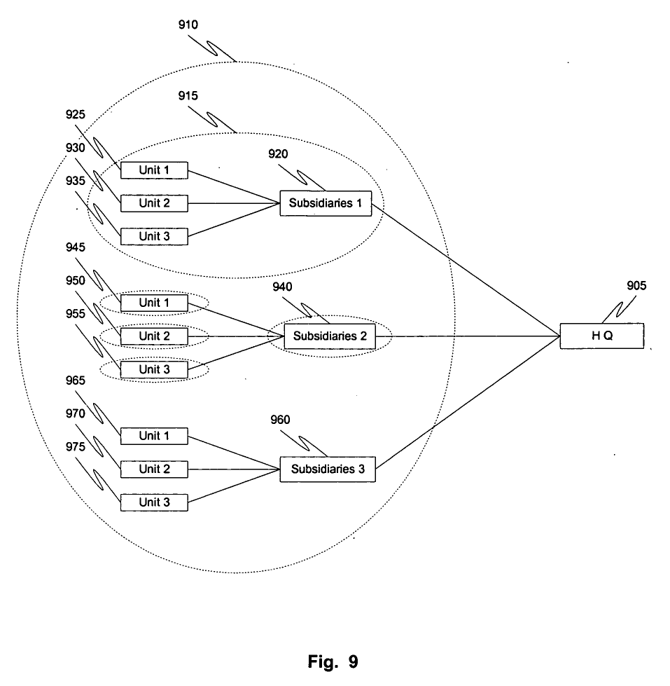

FIG. 9 is a block diagram depicting an industrial organizational structure consisting of a multinational company having subsidiaries, each of these subsidiaries in turn can further comprise of “n” number of units, the purpose for conducting a Audit on its subsidiaries, or units and other such institutional setups.

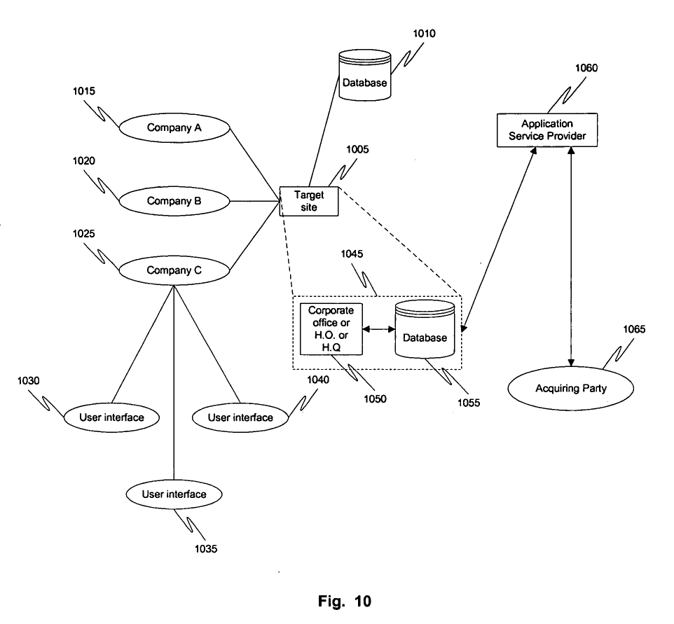

FIG. 10 is a block diagram depicting the process of Due Diligence on a target to be acquired company and its other associated businesses, by the acquiring party using the system at the service provider.

### DETAILED DESCRIPTION OF THE INVENTION:

While the present invention is susceptible to embodiment in various forms, there is shown in the drawings and will hereinafter be described a presently preferred embodiment with the understanding that the present disclosure is to be considered as an exemplification of the invention and is not intended to limit the invention to the specific embodiment illustrated.

In the present disclosure, the words “a” or “an” are to be taken to include both the singular and the plural. Conversely, any reference to plural items shall, where appropriate, include the singular.

The present invention relates to methods and systems for overcoming the limitation of the art, reducing the inefficiency, error and cost associated with traditional means of producing due diligence, legal, financial and other types of audits. The invention accomplishes this by automating, and thus reducing human involvement during the information gathering and analysis phases of the due diligence investigation or legal, financial and other various types of audits, as well as during the generation of customized reports based on such information.

According to an embodiment, the present invention features a method of determining a consequence of an entity performing one or more acts as per a predetermined standard pertaining to the performed act, the method comprising:
providing a question;
entering an answer to the question,;
determining whether the act complies with the predetermined standard based on the answer;
determining the consequence, if the act does not comply with the predetermined standard;
providing information, the information pertaining to the consequence and whether the act complies with the predetermined standard.
   The predetermined standard comprises one of a predetermined legal standard, predetermined financial standard or any other auditing standard.

In a preferred embodiment, the providing a question step further comprises providing the question to a first user based on a first user characteristic, the first user characteristic comprising one ore more of: a first user job classification, a first user geographic location and a first user access level. For example, a first user job classification could be an accountant.

In another embodiment of the invention, the method comprises providing one or more follow up questions from a Question Database based on an analysis of the previous or prior answer to the question. A Question Database will generally reflect the applicable laws of a particular jurisdiction, and may need to change over time. The particular questions stored in the Question Database may also be a reflection of different levels of caution. Accordingly, a Question Database is not a fixed structure and may need to be updated by the service provider or, in the alternative, may be manipulated by a user to provide user-defined questions. This allows the user to interact with the method in a specific and intelligent manner, where the user can provide answer after answer, based on which the method puts forward the next or follow-up question. The answers are saved in an Answer Database and are analyzed by a Data Analyzer. In other preferred embodiments, the method analyzes the user's answer or answers to a preceding question or a set of preceding questions, respectively, by searching one or more databases for information that, based on the user's answer or answers to the preceding question or set of preceding questions, is potentially relevant to the due diligence or financial audit report that is to be generated by the method. In some embodiments, the method analyzes the user's answer or answers to a preceding question or a set of preceding questions, respectively, by searching one or more internal search databases. In other embodiments, the method analyzes the user's answer or answers to a preceding question or a set of preceding questions, respectively, by searching one or more public databases.

In another embodiment of the invention, a method for the construction of an Answer Database, wherein the resulting Answer Database contains data required for the production of a due diligence or legal, financial and various other types of audit report, comprises: presenting to a user a set of questions, wherein the questions are designed to obtain data relevant to a due diligence or financial audit report, and wherein the questions are selected for presentation in an automated manner; recording the user's answers to the questions in the Answer Database; and analyzing the user's answers to the questions, wherein the analysis is performed in an automated manner. In another embodiment, the analysis occurs in an intelligent manner. For example, the data collected can be analyzed with respect to standard validation, status, and compliance checks set by statutory, legal, and/or contractual rules. The data can be further analyzed by cross-checking it against public and/or private knowledge databases made available to the system. Public Database include, e.g., the internet, LexisNexis®, etc. Private Database could be maintained by the service provider and can be accessed, e.g., by means of an intranet, extranet, etc. The Data Analyzer is tagged/monitored by the Session Agent and by the Answer Database. The Data Analyzer monitors and controls the Question Database so that the questions are triggered in accordance with the user's profile and responses to previous questions. The Data Analyzer triggers the Question Database, and prompts the next question on the user terminal's screen. The Session Agent also tags the Question Database and helps to reconnect and continue from the previous incomplete session.

In another embodiment of the invention, all the answers obtained are compared to one or more rules pertaining to the act. In preferred embodiments, the user's answer to each question is evaluated as it is entered. In other preferred embodiments, the user's answers to one or more questions are evaluated after other questions have been answered. In preferred embodiments, the timing of the evaluation of a user's answers is dictated by a Rules Database. This is illustrated in FIG. 6. Based on the data in the answer 610, the rules server checks the data in the answer for validity. If the answer is entered in a valid manner, the rules database is searched to see if any further action is required 625. If further action is required, the rules server triggers the server 635, and the server fetches the relevant rule or necessary action or instructions from the rules database 640. Based on the action or instruction, if further search is required 645, another search is conducted in a private or public database 655. Based on the action or search results, if further analysis is required, a set of logic 675, including impact and probability analysis is conduct and the result of the analysis along with the search results if any, is stored in the result (change in the diagram too) database 680. As used herein, a “Rules Database” is a database that associates particular questions and their potential answers with specific courses of action. For example, if a user is asked to provide the names for all of the trademarks owned by the entity under consideration and the user inputs a particular trademark, the Rules Database could have associated with the trademark question an instruction to search the US Patent and Trademark Office's public databases to determine whether, and when, any of the trademarks have been registered. A Rules Database will generally reflect the applicable laws of a particular jurisdiction, and may need to change over time. The actions stored in the Rules Database may also be a reflection of different levels of caution. Accordingly, a Rules Database is not a fixed structure and may need to be updated by the service provider or, in the alternative, may be manipulated by a user to provide user-defined actions. In some embodiments, the rules also help in the generation of reports. The Rules Database, e.g., can contain maps corresponding to the questions presented, responses received, validation of responses, error messages, and actions to be taken depending upon these other indicators.

In a preferred embodiment, the Rules Database comprises the user-defined validation yardsticks like legal/statutory compliance validations and/or the logical flow (of the answers) validations and the corresponding errors in case the validations fail. The Rules Database further comprises scripts, a library of programs, applets, and/or data related to each question asked and answer entered. Some of this information is used by the Rules Server to determine whether any further analysis or action is required. Further, the Server can use some of this information to take further action (or carry out further analysis). The Rules Database is programmable by the Service Provider and can be updated on a regular basis. The Rules Server uses the Rules Database to control and set the Trigger. In an alternate embodiment the Rules Database can vary depending on the Licensee, Industry, Country, etc. The Service Provider or the Licensee uses the User Interface for modifying and updating the Rules Database.

In another embodiment of the invention, to determine if the act complies with the predetermined standard, one or more internal databases are searched for one or more relevant information, based on the answer to the question. Relevant information comprises information that is related or similar to the answer provided by the user.

In another embodiment of the invention, one or more external databases are searched for one or more relevant information, based on the answer to the question. The external databases comprise public and private databases.

In another embodiment of the invention, one or more internal databases and one or more external databases are searched for one or more of relevant information, based on the answer to the question.

To determine the consequence of the act, the relevant information and the answer provided by the user are compared and analyzed.

In another embodiment of the invention, to provide information pertaining to the act performed, a report is prepared. In a preferred embodiment, the report is customized according to the requirements of a recipient. For instance, if the recipient is the chief financial officer, information relevant to the use of the CFO will be presented in the form of a report. This is illustrated in FIG. 8. When a recipient desires a report, the recipient enters a request 805 and then enters the login and password information. Upon authentication 810, the user profile is checked to determine the template 815. An appropriate template is picked based on the recipient 820. Results required from the result database are obtained by querying the result database 830. Data required from the answer database is obtained by querying the answer database 840, and the results from both the databases are merged with the template 845.

Another embodiment of the invention entails determining the probability of the consequence. Another embodiment of the invention also entails determining the impact of the consequence. This is accomplished through the Impact v/s. Probability Theory module. FIG. 7 illustrates four quadrants, high impact and high probability of the consequence or condition precedent 710, high impact and low probability or disaster recovery or insurance 740, low probability and low impact or condition subsequent 730, and low impact and high probability 720. Therefore, the result of the module can lie in any one of these quadrants, formed by the axes impact and probability. Based on which quadrant the consequence lies in, a rating is obtained for the consequence, such as high importance, urgent, etc. Based on the rating, another embodiment of the invention entails informing or reporting to a relevant authority or recipient this piece of information, impact, probability of consequence, etc.

Another embodiment entails updating a rules database on an ongoing basis, wherein the rules database is one of an internal database and contains one or more rules pertaining to one or more acts. Updating the rules database ensures that all the latest amendments in the predetermined legal, predetermined financial or any other standard are relevant and up to date. This is illustrated in FIG. 5. If the service provider or licensee wants to add or modify the rules database 505, he may do so 510 until the rules are completely updated 515.

Another embodiment of the invention comprises deploying the method over one of a local, public network or wide area network.

As illustrated in FIG. 1, another embodiment of the invention comprises a system for determining a consequence of an entity performing one or more acts as per a predetermined standard pertaining to the performed act, the system comprising
a computing system including a processor and a memory, the processor and the memory in communication with each other, wherein the memory further comprises a program, the program comprising a Question Database 102, wherein the Question Database provides a question to a user 101; an answer database 103 to save an answer to the question; a Rules Server to determine any required action based on the data in the Rules Database, Question database and Answer database 107, the Rules Database provides one or more actions corresponding to the act; a Server to fetch one or more action/instruction from the Rules Database corresponding to that act for further analysis; a search agent 111 to search for one or more of a relevant information in one or more internal databases and one or more external database 112 and 113; a set of logic 117 for determining the consequence based on the relevant information and the answer; and a result database 118 to store and provide the answer, the consequence and the relevant information.

In a preferred embodiment of the invention, when a user starts using the program, the question database provides a question to the user. The answer given by the user is the recorded and saved in an answer database. The answer is also sent to a data analyzer 104, which is used for analyzing the answer to the question. The Data Analyzer helps predict the next or follow—up question to be presented to the user. The Data Analyzer is tagged/monitored by the Session Agent and by the Answer Database. The Data Analyzer monitors and controls the Question Database so that the questions are triggered in accordance with the user's profile and responses to previous questions. The Data Analyzer triggers the Question Database, and prompts the next question on the user terminal's screen. The Session Agent also tags the Question Database and helps to reconnect and continue from the previous incomplete session.

An embodiment of the invention allows the user to save the answers provided by him during a session, if the session terminates. This is accomplished through a session agent 105.

In an embodiment of the invention, a Server 106 calls for the answer from the answer database, as and when an answer is recorded. For every answer or series of answers, the rules server queries the rules database 107 for the rule relevant to the question and the answer to determine whether any further action is required to be taken. If further action is required, the Rules server 108 uses the Trigger 109 to notify the server 106. The Trigger interacts with the Rules Server and the Server and acts as a queue for all the action to be taken by the Server. The Trigger makes the Rules Server free from having to continue scanning the answers to determine for any further action to be taken. When it receives an indication from the Rules Server that further action is required, it triggers the Server and directs it to an appropriate location in the Rules Database for further action. The Rules Server is connected to the Rules Database; the Answer Database, the Trigger, and the Session Agent. The Rules Server validates the entered data, analyzes the Answer Database and the Rules Database to determine whether any analysis has to be taken on the data. On such determination, it shall set the Trigger that in turn triggers the Server. In some embodiments, the Rules Server also indicates to the Service Provider, Licensee, or User any validation or user-defined errors.

In an embodiment of the invention, a rules database determines as to when the answers provided by the user will be evaluated.

In another embodiment of the invention, the server triggers a search agent 111 to search an external database such as a public database 112 or a private database 113 for relevant information pertaining to the answer on a need basis. Based on the relevant information provided, a set of logic 117 in conjunction with an Impact v/s Probability Theory Module 116 provides the results or the consequence if the answer does not comply with the predetermined standards. As used herein, a “Set of Logic” comprises one or more computational subroutines designed to conduct further analysis including provide rating to particular answers or results based on pre-determined standards and also format information and/or data into a format that can be readily assimilated. For example, the data might be output in the form of an Impact vs. Probability Theory diagram.

The server collects all the information, the answers, the rules relevant to the answers and the relevant information sought from the external databases, and provides all these to the result database.

In another embodiment of the invention, a report designer server 119 obtains the results from the result database, and a report template from a report template database 120. In some embodiments, the templates are customized with respect to the user, e.g., a CEO, CFO, attorney, accountant, or investor, of the resulting report. The report templates can be structured as a form into which data taken from associated databases, such as the Answer Databases, is entered. Alternatively, the report templates can be structured as associated clauses or sentences, wherein particular clauses or sentences are drawn into the final report depending upon the data and information present in associated databases, such as the Answer Databases. A Report Template Database will generally reflect the applicable laws of a particular jurisdiction, and may need to change over time. Accordingly, a Report Template Database is not a fixed structure and may need to be updated by the service provider or, in the alternative, may be manipulated by a user to meet user-defined informational needs.

The present invention can be deployed over one of a local or wide area network. According to FIG. 2, a public database 211 can be accessed with a license, through the internet, through various client environments such as a stand-alone user 214 or LAN system 221 or a LAN system 215 containing servers 216 and 217.

Before a user starts using the program for conducting any audit or due diligence, the user must register. FIG. 3 depicts an embodiment of the invention wherein the user registers with the program. The program prompts the licensee to sign-up 305 and asks for usage details 310. The licensee is an institution in this case, and the user is employed at the licensee. Based on the usage details provided, the license fees are determined 315. The licensee is given an option for payment of fees 320. If the fees have been paid, an account is set up for the user as per the user profile and access rights provided by the licensee 330. The user is informed about the setup and password 335 and user details are modified 340.

In another embodiment of the invention, when the user starts a new session or wants to continue working on a previous session, the user is requested to login or sign-up 405. Once the user sign's up, the user name and password are validated 410. If the user is starting a new session, a first question is displayed 430. If the user is continuing a previously saved session 435, a question as per analysis is presented to the user 440. From here onwards, any session, old or new, is handled similarly. The responses to questions are saved in an answer database 445. The answer is analyzed 450 to determine the next question and the session is saved 455. If no more questions can be identified, the session comes to an end 465.

In another embodiment as shown in FIG. 9, the present invention allows a company, with headquarters in a first location 905 to obtain information about its various subsidiaries 920, 940 and 960 located in three different countries. If necessary, the invention allows the headquarters to obtain information about specific units of a particular subsidiary. Therefore, the headquarter company must have each subsidiary submit information for their particular location and function and a recipient such as the CEO, CFO, general counsel, etc. may obtain relevant reports on due diligence for each of these subsidiaries.

In another embodiment, as illustrated in FIG. 10, the invention allows for the continuous and automatic delivery of due diligence reports internally within a corporation. A first user located at a first location, Company A 1015, will be required to provide answers based on a question and one or more follow-up questions provided as described earlier, from a Question Database. Similarly, a second user from a second location, Company B 1020, will be required to provide answers. Their answers will be stored in an answer database stored at the target site 1005. The target site is maintained by a service provider and hosts a plurality of databases. A recipient such as a CFO or CEO at the head quarters of the company 1050 or licensee of the service provider can obtain a customized report on a continuous basis to ensure that procedures are complied with, at various subsidiaries such as Companies A and B. An acquiring party 1065 may also find this information that is continuously being obtained, useful to make a sound acquisition.

1. A method for determining a consequence of an entity performing one or more acts as per a predetermined standard pertaining to the performed act, the method comprising:
providing a question;
entering an answer to the question,;
determining whether the act complies with the predetermined standard based on the answer;
determining the consequence, if the act does not comply with the predetermined standard;
providing information, the information pertaining to the consequence and whether the act complies with the predetermined standard.

2. The method of claim 1, wherein the providing a question step further comprises providing the question to a first user based on a first user characteristic, the first user characteristic comprising one ore more of: a first user job classification, a first user geographic location and a first user access level.

3. The method of claim 1, wherein the providing a question step further comprises providing one or more follow-up questions from a question database based on an analysis of one or more prior answers by a data analyzer.

4. The method of claim 1, wherein the determining whether the act complies step further comprises comparing the answers to one or more rules corresponding to the act.

5. The method of claim 1, wherein the determining whether the act complies step further comprises searching one or more of an internal database for one or more of a relevant information based on the answer to the question.

6. The method of claim 1, wherein the determining whether the act complies step further comprises searching one or more of an external database for one or more of a relevant information based on the answer to the question.

7. The method of claim 1, wherein the determining whether the act complies step further comprises searching one or more of an internal database and one or more of an external database for one or more of a relevant information based on the answer to the question.

8. The method of claim 5, wherein the determining the consequence step further comprises comparing one or more of the answers and one or more of the relevant information based on the answer.

9. The method of claim 6, wherein the determining the consequence step further comprises comparing one or more of the answers an one or more of the relevant information based on the answer.

10. The method of claim 7, wherein the determining the consequence step further comprises comparing one or more of the relevant information based on the answer.

11. The method of claim 1, wherein the providing the information step further comprises preparing a report.

12. The method of claim 9, wherein the providing the information step further comprises customizing the report according to a recipient.

13. The method of claim 1, wherein providing the information step further comprises
querying the answer database to give all the answers;
querying the result database to give results;
merging the results and the answers.

14. The method of claim 1, wherein the predetermined standard comprises one of a predetermined legal standard, a predetermined financial standard or an auditing standard.

15. The method of claim 1, further comprising
determining the probability of the consequence.

16. The method of claim 1, further comprising
determining the impact of the consequence.

17. The method of claim 1, further comprising:
saving one or more answers.

18. The method of claim 1, further comprising:
resuming a session, if the session was terminated.

19. The method of claim 1, further comprising
updating a rules database.

20. The method of claim 1, wherein the method can be deployed over one of a local area network or a wide area network.

21. A system for determining a consequence of an entity performing one ore more acts as per a predetermined standard pertaining to the performed act, the system comprising:
a computing system including a processor and a memory, the processor and the memory in communication with each other, wherein the memory further comprises a program, the program comprising a question database, wherein the question database provides a question to a user; an answer database to save an answer to the question; a rules server to determine any required action based on the data in the rules database, question database or answer database, wherein the rules database provides one or more actions corresponding to the act; a server to fetch one or more actions from the rules database corresponding to the act for further analysis; a search agent to search for one or more of a relevant information in one or more internal databases and one or more external database;
a set of logic for determining the consequence based on the relevant information and the answer; and a result database to store and provide the answer, the action, the consequence and the relevant information.

22. The system of claim 21, wherein the question database further comprises a plurality of follow-up questions.

23. The system of claim 21, further comprising a data analyzer, wherein the answer to the question is analyzed by the data analyzer.

24. The system of claim 21, further comprising a session agent, the session agent responsible for resuming a session, if the session was terminated.

25. The system of claim 21, wherein a service provider or a licensee can update the rules database.

26. The system of claim 21, further comprising a report designer server and a report template database, wherein the report designer server is in communication with the report template database, the answer database and the result database.

27. The system of claim 21, wherein a service provider or a licensee can update the report template database as per a recipient.

28. The system of claim 21, wherein system provides a due diligence and legal and financial audit.

29. A method of conducting due diligence, the method comprising:
a service provider maintaining a target site for conducting due diligence;
a plurality of users providing answers to the target site pertaining to one or more acts; and,
a licensee accessing the target site to obtain a customised report.
Wherein, the plurality of users provides answers based on a question and one or more follow-up questions presented to the users by the target site, wherein the follow-up questions are based on the previous answers, wherein the answers are analyzed based on a plurality of databases maintained by the service provider.
